(19) United States
(12) Patent Application Publication
(10) Pub. No.: US 2004/0181680 A1
(43) Pub. Date: Sep. 16, 2004

(54) Reproducing method and apparatus, recording method and apparatus , program recording medium and program, and recording medium

(75) Inventors: Miki Abe, Kanagawa (JP); Tadao Yoshida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/781,773

(22) Filed: Feb. 20, 2004

(30) Foreign Application Priority Data
Mar. 5, 2003 (JP) 2003-058377

(51) Int. Cl. H04K 1/00

(52) U.S. Cl. 713/193; 705/57

(57) ABSTRACT

The present invention is intended to restrict the reproducing of disk-copyable recording media. A PC records content to an optical disk along with a product ID for identifying the recording environment of the PC. When the optical disk recorded by the PC is loaded on it, a reproducing apparatus reads the product ID and, if initialization product ID has not been registered with a product ID management table, stores the product ID of the PC into the product ID management table as an initialization product ID. If initialization product ID has already been registered, the reproducing apparatus compares the registered initialization product ID with the product ID of the PC and, if a mismatch is found between them, disables or restrict the reproducing of the optical disk. The present invention is applicable to those reproducing apparatuses which reproduce optical disks recordable with copyright-protected content.

### BACKGROUND OF THE INVENTION

The present invention relates to a reproducing method and apparatus, a recording method and apparatus, a program recording medium and program, and a recording medium and, more particularly to a reproducing method and apparatus, a recording method and apparatus, a program recording medium and program, and a recording medium which are capable of applying reproducing restriction on disk-copyable recording media.

Recently, there exist recorded recording media such as Label Gate CDs on which authentication IDs are recorded along with the content copyright-protected by means of encryption for example.

The following describes a method of content copyright protection by use of Label Gate CD 1 with reference to FIG. 1. As shown in FIG. 1, the Label Gate CD 1 is configured by a first session area 11 and a second session area 12. The first session area 11 contains reproducing data for copy-controlled CE (Consumer Electronics) equipment. The second session area 12 contains content 21 encrypted as reproducing data for PC (Personal Computer) and a PID (Postscripted Identification) which is an authentication ID for use in the authentication for copying the content 21 to a hard disk 13 and reproducing it therefrom. As shown in FIG. 1, the content 21 is configured by compressed audio data for example.

The second session area 12 also contains a disk application 14 dedicated to reading the PID. When the Label Gate CD 1 is loaded in a PC 2, the PC 2 starts the key operation block 14 on the PC 2. The disk application 14 reads the PID from the Label Gate CD 1 and sends the PID to a music distribution server 4 as shown in non-patent document 1 via the Internet 3. By use of the PID, the music distribution server 4 manages the access count of the content 21 recorded on the Label Gate CD 1 and executes verification and authentication to see whether the PID received from the PC 2 is used for the first time or the second time or on for the content 21 of the Label Gate CD 1 to be copied onto the hard disk 13.

The music distribution server 4 also has a license server 16. When the music distribution server 4 authenticates the PID received from the PC 2, the license server 16 issues a license key 22 for decrypting the encrypted content 21 recorded on the Label Gate CD 1 to the PC 2 via the Internet 3. The PC 2 receives the license key 22 from the license server 16 via the Internet 3 and stores the received license key 22 into the hard disk 13.

Consequently, the content 21 on the Label Gate CD 1 is copied onto the hard disk 13 and decrypted by the stored license key 22, so that the PC 2 can reproduce the content 21 from the Label Gate CD 1 by use of a reproducing application 15.

As described above, in the Label Gate CD 1, the online authentication by means of the PC 2 executes the reproducing management of the content 21 on the basis of PID, thereby protecting the copyright of the content 21.

In the PC 2, the content copyright-protected by means of encryption can be recorded from a primary recording medium such as the hard disk 13 to a disk-copyable secondary recording medium such as CD-R (Compact Disk Recordable) by use of CCI (Copy Control Information) shown in non-patent document 2 and the like.

The following describes a method of protecting the copyright of content which is copied onto disk-copyable secondary recording media with reference to FIG. 2. As shown in FIG. 2, the PC 2 has a disk recording application 33 for recording content 41 from the hard disk 13 to a CD-R 31. It should be noted that, for the content 41, encrypted content 41-1 obtained from the Label Gate CD 1 or the music distribution server 4 shown in FIG. 1 is decrypted by its license key 41-2 and recorded to the hard disk 13 in the form of plaintext.

The disk recording application 33 generates the information unique to the content 41, device, and application (for example, the information configured by the unique ID for each application installed on the PC 2 and the time and random number information stored in the hard disk 13) as a product ID 43 having a combination unique to each device having primary recording media such as the hard disk 13. In writing to the CD-R 31, the disk recording application 33 stores the generated product ID 43 into the CD-R 31 along with the content 41.

By means of this product ID 43, the PC 2 in which the content 41 is recorded on the CD-R 31, the secondary recording medium, is identified and authenticated, so that the reproducing of the content 41 is disabled on any PCs and their applications other than the authenticated PC 2 and its applications.

On the other hand, with general-purpose secondary recording media such as generally widely spread CD-Rs and their disk drives, not only the content 41 but also the content 41 and its generated product ID 43 can be copied, thereby sometimes letting users to easily create copied recording media. In such a case, the above-mentioned product ID 43 allows the identification of the PC 2 which recorded the content 41 on the secondary recording medium CD-R 31, so that the copied recording media cannot be reproduced on any PCs and their applications other than the authenticated content 41 and its applications, thereby preventing the unlimited spreading of the right of reproducing from occurring.

[Non-patent document 1]

Label Gate Co. LTD, “Label Gate”, [online], searched Feb. 19, 2003, URL http://www.labelgate.com/

[Non-patent document 2]

4C Entity, LLC, “4C Entity”, [online] [searched Feb. 19, 2003], URL http://www.4centity.com/

However, with a reproducing device (such as an audio device) 32 for reproducing the CD-R 31, the secondary recording medium, for example, distinction cannot be made between the content 41 on the CD-R 31 written by the PC 2 or the disk recording application 33 and the content on a copied recording medium copied by another PC or its applications. Therefore, the above-mentioned related-art configurations present a problem that the spreading of the right of reproducing on the reproducing device 32 cannot be prevented.

Although a method is available of promoting copyright protection by use of other than general-purpose secondary recording media such as generally widely spread CD-Rs and their disk drives. This method, however, presents a problem of significantly impairs general versatility even if the unlimited spreading of the right of reproducing on the reproducing device 32 can be suppressed.

### SUMMARY OF THE INVENTION

It is therefore an object of the present invention to execute reproducing restriction on disk-copyable recording media.

In carrying out the invention and according to the first aspect thereof, there is provided a reproducing method for reproducing information recorded to a recording medium, including the steps of: obtaining from the recording medium, a recording ID for identifying a recording environment in which the information was recorded to the recording medium; determining as a first determination step whether or not the recording ID has already been registered as an initialization recording ID; registering the recording ID obtained in the obtaining step as the initialization recording ID if the initialization recording ID is found not yet registered in the first determination step; determining, as second determination step, whether or not the recording ID obtained in the obtaining step matches the initialization recording ID if the initialization recording ID is found already registered in the first determination step; and executing control of disabling or restricting the reproducing of the information recorded on the recording medium if the recording ID is found mismatching the initialization recording ID in the second determination step.

In the above-mentioned reproducing method, the recording ID may be an ID for identifying a recording apparatus which recorded the information to the recording medium.

In the above-mentioned reproducing method, the initialization recording ID, once registered, cannot be deleted and rewritten.

The above-mentioned reproducing method, further including the steps of: if the recording ID is found matching with the initialization recording ID in the second determination step, reading, from the recording medium, an encryption key by which the information was encrypted; and by use of the encryption key read in the reading step, decrypting the information recorded to the recording medium; wherein the reproducing control step also executes control of reproducing the information decrypted in the decryption step.

In carrying out the invention and according to a second aspect thereof, there is provided a reproducing apparatus, including: obtaining means for obtaining, from the recording medium, a recording ID for identifying a recording environment in which the information was recorded to the recording medium; first determining means for determining whether or not the recording ID has already been registered as an initialization recording ID; registering means for registering the recording ID obtained by the obtaining means as the initialization recording ID if the initialization recording ID is found not yet registered in the first determination step; the recording ID obtained by the obtaining means matches the initialization recording ID if the initialization recording ID is found already registered by the first determining means; and reproducing control means for executing control of disabling or restricting the reproducing of the information recorded on the recording medium if the recording ID is found mismatching the initialization recording ID by the second determining means.

In carrying out the invention and according to a third aspect thereof, there is provided a first program recording medium including the steps of: obtaining, from the recording medium, a recording ID for identifying a recording environment in which the information was recorded to the recording medium; determining as a first determination step whether the recording ID has already been registered as an initialization recording ID; registering the recording ID obtained in the obtaining step as the initialization recording ID if the initialization recording ID is found not yet registered in the first determination step; determining, as second determination step, whether the recording ID obtained in the obtaining step matches the initialization recording ID if the initialization recording ID is found already registered in the first determination step; and executing control of disabling or restricting the reproducing of the information recorded on the recording medium if the recording ID is found mismatching the initialization recording ID in the second determination step.

In carrying out the invention and according to a fourth aspect thereof, there is provided a first program, including the steps of: obtaining, from the recording medium, a recording ID for identifying a recording environment in which the information was recorded to the recording medium; determining as a first determination step whether the recording ID has already been registered as an initialization recording ID; registering the recording ID obtained in the obtaining step as the initialization recording ID if the initialization recording ID is found not yet registered in the first determination step; determining, as second determination step, whether the recording ID obtained in the obtaining step matches the initialization recording ID if the initialization recording ID is found already registered in the first determination step; and executing control of disabling or restricting the reproducing of the information recorded on the recording medium if the recording ID is found mismatching the initialization recording ID in the second determination step.

In carrying out the invention and according to a fifth aspect thereof, there is provided a recording method, including the steps of: generating a recording ID for identifying a recording environment in which the information is recorded to the recording medium; encrypting the information by an encryption key; and recording the information encrypted in the encryption step to the recording medium and recording the recording ID generated in the generating step along with the encryption key.

In carrying out the invention and according to a sixth aspect thereof, there is provided a recording apparatus, including: generating means for generating a recording ID for identifying a recording environment in which the information is recorded to the recording medium; an encrypting means for encrypting the information by an encryption key; and a recording means for recording the information encrypted by the encrypting means to the recording medium and recording the recording ID generated by the generating means along with the encryption key.

In carrying out the invention and according to a yet different aspect thereof, there is provided a second program recording medium including the steps of: generating a recording ID for identifying a recording environment in which the information is recorded to the recording medium; encrypting the information by an encryption key; and recording the information encrypted in the encryption step to the recording medium and recording the recording ID generated in the generating step along with the encryption key.

In carrying out the invention and according to a eighth aspect thereof, there is provided a second program including the steps of: generating a recording ID for identifying a recording environment in which the information is recorded to the recording medium; encrypting the information by an encryption key; and recording the information encrypted in the encryption step to the recording medium and recording the recording ID generated in the generating step along with the encryption key.

In carrying out the invention and according to a ninth aspect thereof, there is provided a recording medium for recording information which records the information and a recording ID for identifying a recording environment in which the information was recorded to the recording medium.

The above-mentioned reproducing apparatus may be either an independent apparatus or one of the blocks of a recording/reproducing apparatus that carries out reproducing processing.

The above-mentioned recording apparatus may be either an independent apparatus or one of the blocks of a recording/reproducing apparatus that carries out recording processing.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

These and other objects of the invention will be seen by reference to the description, taken in connection with the accompanying drawing, in which:

FIG. 1 is a schematic diagram illustrating a content copyright protection method based on Label Gate CD;

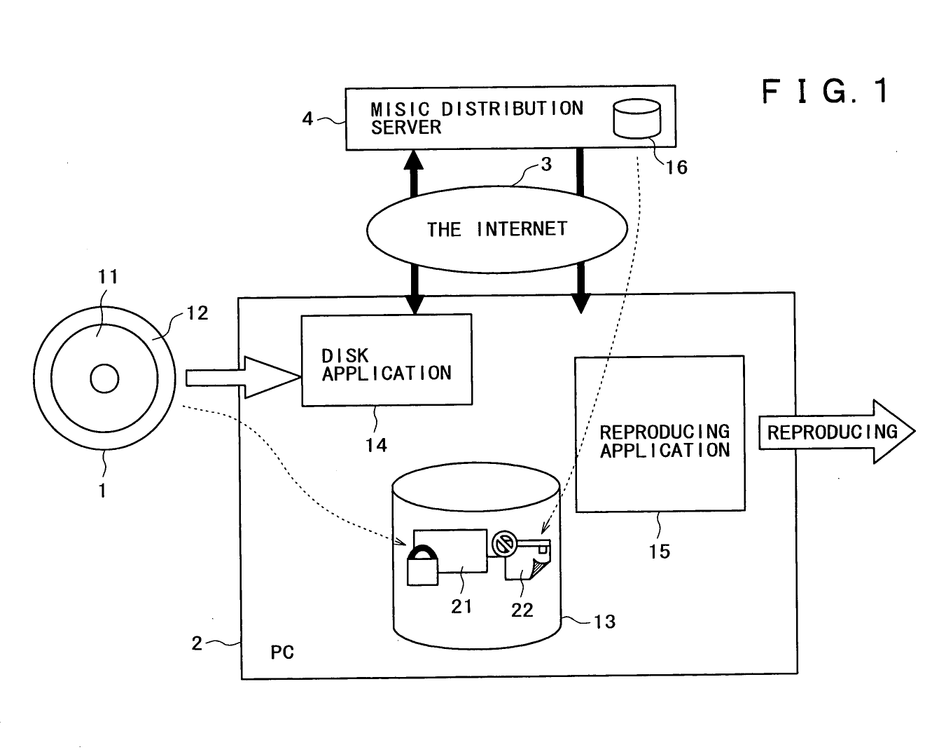

FIG. 2 is a schematic diagram illustrating a content copyright protection method against conventional secondary recording media;

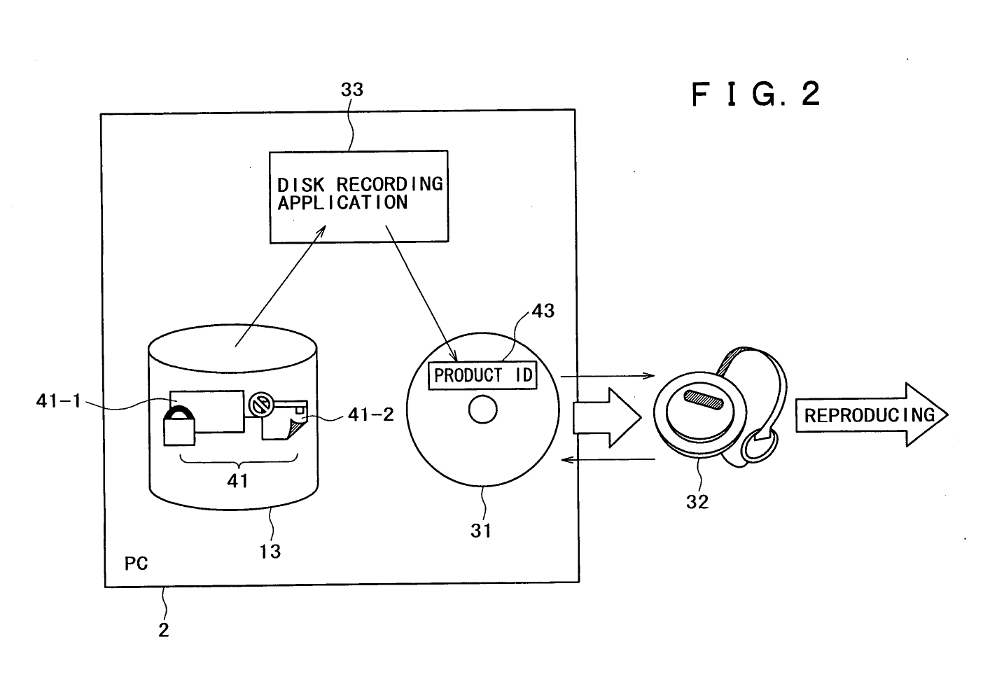

FIG. 3 is a schematic diagram illustrating an exemplary configuration of a recording/reproducing system to which the present invention is applied;

FIG. 4 is a block diagram illustrating an exemplary configuration of a PC shown in FIG. 3;

FIG. 5 is a functional block diagram illustrating an exemplary configuration of the PC at it is when a disk recording program shown in FIG. 4 is executed;

FIG. 6 is a schematic diagram illustrating an exemplary operation of the PC shown in FIG. 3;

FIG. 7 is a schematic diagram illustrating another exemplary operation of the PC shown in FIG. 3;

FIG. 8 is a diagram illustrating an exemplary configuration of optical disk data to be recorded by the PC shown in FIG. 3;

FIG. 9 is a block diagram illustrating an exemplary configuration of a reproducing apparatus shown in FIG. 3;

FIG. 10 is a flowchart for describing the processing of recording to an optical disk loaded on the PC shown in FIG. 3;

FIG. 11 is a flowchart for describing the processing of reproducing of an optical disk loaded on the PC shown in FIG. 3;

FIG. 12 is a schematic diagram illustrating another exemplary configuration of the recording/reproducing system shown in FIG. 3;

FIG. 13 is a schematic diagram illustrating still another exemplary configuration of the recording/reproducing system shown in FIG. 3;

FIG. 14 is a diagram illustrating an exemplary configuration of a product ID management table shown in FIG. 9; and

FIG. 15 is block diagram illustrating another exemplary configuration of a recording/reproducing system to which the present invention is applied.

### DETAILED DESCRIPTION OF THE PREFERRED EMBODIMENTS

This invention will be described in further detail by way of example with reference to the accompanying drawings.

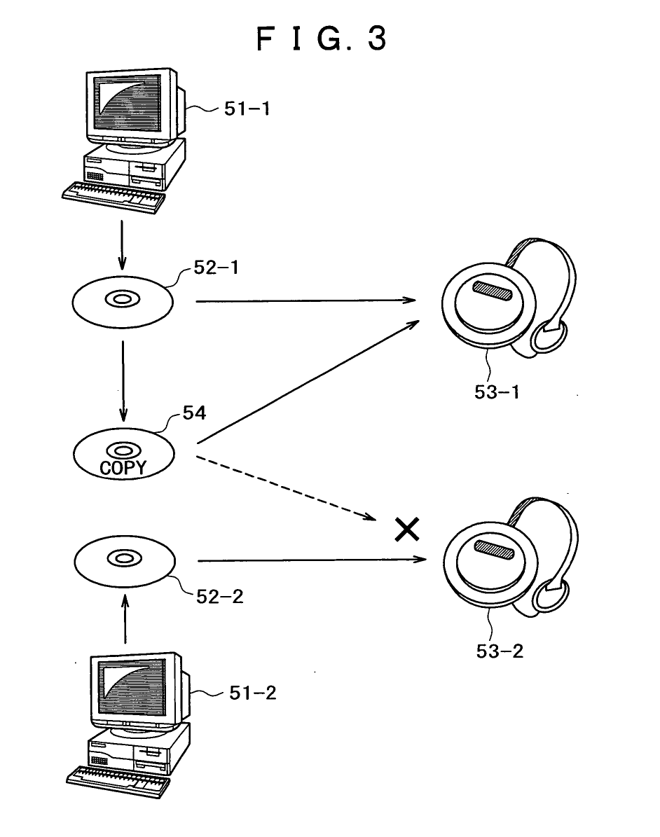

Now, referring to FIG. 3, there is shown an exemplary configuration of a recording/reproducing system practiced as one embodiment of the invention. In FIG. 3, user A owns a PC (Personal Computer) 51-1 and a reproducing apparatus 53-1. The PC 51-1 of user A stores, in the form of plaintext, copyright-protected content such as ripping and EMD (Electronic Music Distribution) data downloaded from a content distribution server, not shown, via a network, not shown. As shown in FIG. 3, content is configured by compressed audio data.

The PC 51-1 encrypts stored content by a content key and records the encrypted content to an optical disk 52-1. Also, the PC 51-1 generates a product ID of the PC 51-1 for the identification of the recording environment (or recording attribute) at the time when content is recorded to the optical disk 52-1. The PC 51-1 encrypts the content key by an encryption key common to the reproducing apparatus 53-1 and records the product ID of the PC 51-1 to the optical disk 52-1 along with the encrypted content key. It should be noted that the common encryption key was stored in the PC 51-1 and the reproducing apparatus 53-1 before the shipment from factory for example.

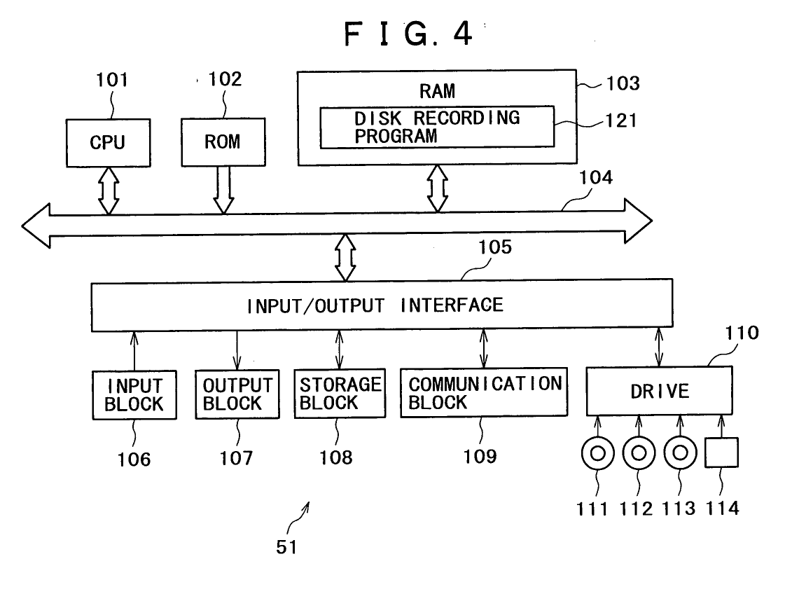

The product ID is configured by a format version for identifying the contents of content, whether they are audio data or video data and the like, a factory ID for the identification of the attribute of the PC 51-1 by use of a storage block 108 and a CPU 101 (shown in FIG. 4 to be described later), a content ID for the identification of the attribute of content by use of the codec mode, or MAC (Media Access Control address) for the identification of each Ethernet (trademark) card, or a combination thereof.

The optical disk 52-1 is configured by a general-purpose writable recording medium such as CD-R (Compact Disk Recordable), CD-RW (Compact Disk ReWritable), or a DVD (Digital Versatile Disk). The optical disk 52-1 is recorded with content, a content key, and a product ID (Identification) by the PC 51-1.

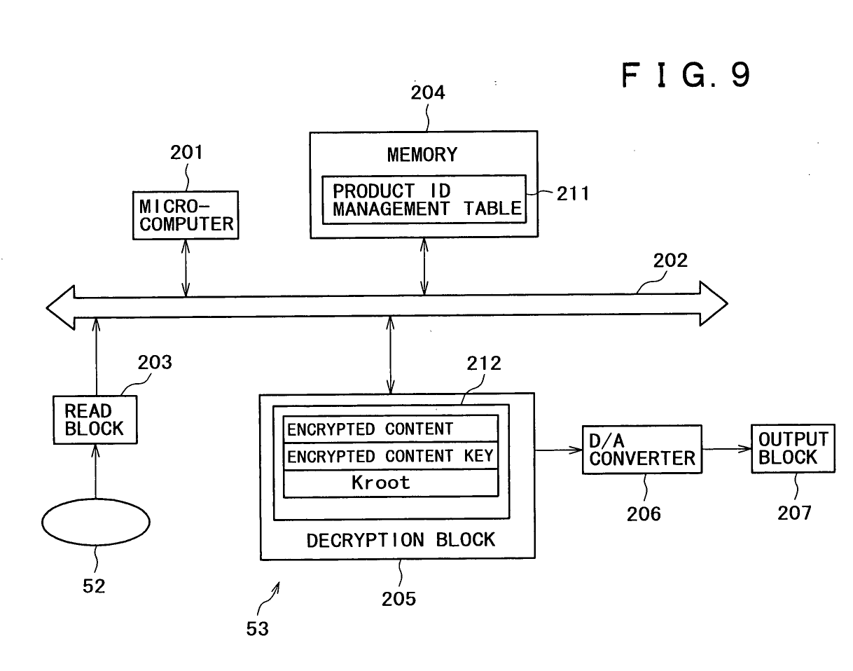

User A reproduces, the optical disk 52-1 recorded with content by the PC 51-1 on his reproducing apparatus 53-1. The reproducing apparatus 53-1 is configured by a CE (Consumer Electronics) device such as a portable audio device. When the optical disk 52-1 recorded by the PC 51-1 is loaded on it, the reproducing apparatus 53-1 reads the product ID of the PC 51-1 and stores it into a product ID management table 211 as an initialization product ID shown in FIG. 9 to be described later. Consequently, the reproducing apparatus 53-1 is initialized by the product ID of the PC 51-1. It should be noted that, once initialized, the product ID management table 211 cannot be deleted or rewritten. The reproducing apparatus 53-1 reads content from the optical disk 52-1, decrypts the content by use of the content key recorded to the optical disk 52-1, and reproduces the decrypted content.

On the other hand, user B owns a PC 51-2 and a reproducing apparatus 53-2. The PC 51-2 of user B stores, in the form of plaintext, the copyright-protected content downloaded from a content distribution site for example, not shown, via a network, not shown, as with the PC 51-1. The PC 51-2 encrypts the stored content by a content key and records the encrypted content in an optical disk 52-2. The PC 51-2 also generates the product ID of the PC 51-2 onto the optical disk 52-2. The PC 51-2 encrypts the content key by an encryption key common to the reproducing apparatus 53-2 and records the product ID of the PC 51-2 to the optical disk 52-2 along with the encrypted content key.

User B reproduces, the optical disk 52-2 recorded with content by the PC 51-2 on his reproducing apparatus 53-2. When the optical disk 52-2 recorded by the PC 51-2 is loaded on the reproducing apparatus 53-2, the reproducing apparatus 53-2 reads the product ID of the PC 51-2 and stores it in the product ID management table 211 as an initialization product ID, as with the reproducing apparatus 53-1. Consequently, the reproducing apparatus 53-2 is initialized by the product ID of the PC 51-2. The reproducing apparatus 53-2 reads the content recorded on the optical disk 52-2, decrypts the content by the content key recorded to the optical disk 52-2, and reproduces the decrypted content.

The PC 51-1 has a capability of copying the optical disk 52-1. By use of this capability, an optical disk 54 which is a copy of the optical disk 52-1 (the optical disk 54 will hereafter be referred to as a copy disk 54 for distinction from the optical disk 52-1) is generated. The copy disk 54 which is a copy of the optical disk 52-1 is recorded with all data (content, the content key and the product ID) recorded on the optical disk 52-1. Therefore, the copy disk 54 has the same product ID of the PC 51-1 as that of the optical disk 52-1.

When the copy disk 54 is loaded on it, the reproducing apparatus 53-1 reads the product ID and compares it with the initialization product ID of the product ID management table 211 of the reproducing apparatus 53-1. In this example, because the product ID of the PC 51-1 is stored as the initialization product ID and the product ID of the copy disk 54 is also the product ID of the PC 51-1, a match is found between both the product IDs. Consequently, the same right of reproducing as with the optical disk 52-1 is given to the copy disk 54 in the reproducing apparatus 53-1, so that the reproducing apparatus 53-1 can read content from the copy disk 54, decrypt the content by use of the content key recorded to the copy disk 54, and reproduce the decrypted content.

Likewise, when the copy disk 54 which is a copy of the optical disk 52-1 is loaded on it, the reproducing apparatus 53-2 reads the product ID and compares it with the initialized produced ID of the product ID management table 211 of the reproducing apparatus 53-2. Because the product ID of the optical disk 52-2 is stored as the initialization product ID in this example and the product ID of the copy disk 54 is the product ID of the PC 51-1, there is a mismatch between both the product IDs. Therefore, the reproducing of the content recorded to the copy disk 54 is disabled or restricted. Namely, the reproducing apparatus 53-2 executes the restrictive processing such as the prohibition of the reproducing of the content recorded to the copy disk 54, the reproducing of only a particular band of the content, or the reproducing of only a particular period of time of the content. It should be noted that, if the optical disk 52-1 is loaded instead of the copy disk 54 on the reproducing apparatus 53-2, the reproducing of the content of the optical disk 52-1 is restricted in the same manner as the copy disk 54.

As described above, when the reproducing apparatus is initialized by the product ID of a first loaded optical disk and, after the initialization, any other optical disks recorded with other product IDs are loaded on that reproducing apparatus, the reproducing of these optical disks is restricted. Consequently, the unlimited spreading of the right of reproducing can be disable for disk-copyable recording media.

It should be noted that, in what follows, if there is no need for make distinction between the PC 51-1 and the PC 51-2, the optical disk 52-1 and the optical disk 52-2, and the reproducing apparatus 53-1 and the reproducing apparatus 53-2, they will be generically referred to as the PC 51, the optical disk 52, and the reproducing apparatus 53.

Referring to FIG. 4, there is shown an exemplary configuration of the PC 51. The PC 51 incorporates a CPU (Central Processing Unit) 101. The CPU 101 is connected to an input/output interface 105 via a bus 104. The bus 104 is connected to a ROM (Read Only Memory) 102 and a RAM (Random Access Memory) 103.

The input/output interface 105 is connected to an input block 106 constituted by a keyboard and a mouse for example, an output block 107 constituted by a display device based on LCD (Liquid Crystal Display) and a speaker and the like, a storage block 108 constituted by a hard disk, and a communication block 109 constituted by a modem or a terminal adaptor. The communication block 109 executes communication processing via a network, not shown. The input/output interface 105 is also connected to a drive 110 which reads/writes data with recording media such as a magnetic disk 111, an optical disk 112, a magneto-optical disk 113, and a semiconductor memory 114.

The CPU 101 executes a variety of processing operations to be described later in accordance with a disk recording program 121 which is read from any of the recording media, the magnetic disk 111 through the semiconductor memory 114, into the storage block 108 and loaded from it into the RAM 103.

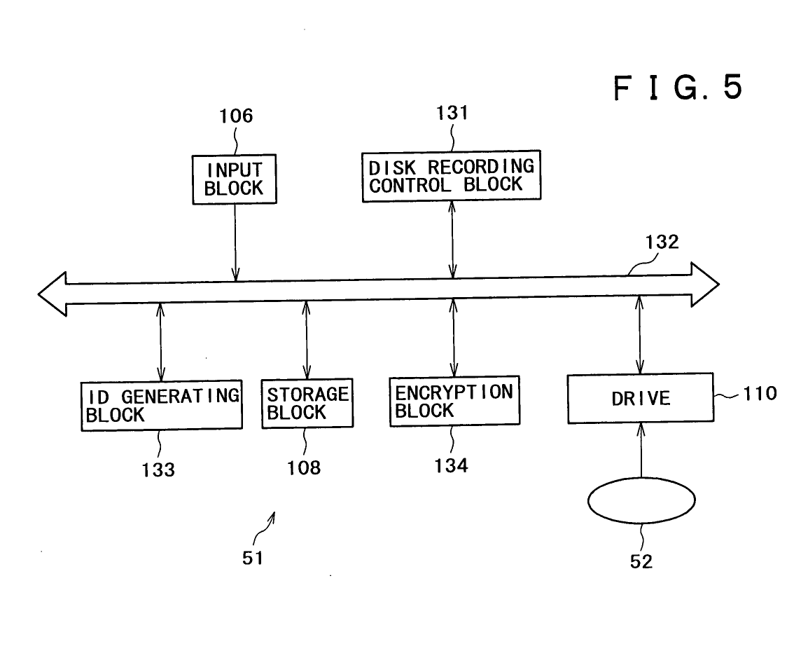

Referring to FIG. 5, there is shown a block diagram illustrating functions of the PC 51 at the time when the disk recording program 121 is executed by reading it from any of the recording media, the magnetic disk 111 through the semiconductor memory .114, into the storage block 108 and loading it into the RAM 103.

A disk recording control block 131 controls, via a bus 132, other components of the PC 51 on the basis of user operation entered through the input block 106 in order to record content stored in the storage block 108 to the optical disk 52 loaded on the drive 110. The bus 132 is connected to the input block 106, an ID generating block 133, the storage block 108, an encryption block 134, and the drive 110.

The ID generating block 133 generates, under the control of the disk recording control block 131, a product ID for the identification of the PC 51, the disk recording program 121, and the recording environment (or attribute) in recording the attribute for example of the content to be recorded and supplies the generated product ID to the drive 110 via the bus 132.

Under the control of the disk recording control block 131, the encryption block 134 reads content from the storage block 108 and encrypts the content by the content key. The encryption block 134 supplies the encrypted content to the drive 110 via the bus 132. Also, the encryption block 134 encrypts the content key by the encryption key common to the reproducing apparatus 53 and supplies the encrypted content key to the drive 110 via the bus 132. It should be noted that the encryption key was registered in the PC 51 at the time of its shipment in advance.

Under the control of the disk recording control block 131, the drive 110 records the encrypted content supplied from the encryption block 134 to the optical disk 52. Also, under the control of the disk recording control block 131, the drive 110 records the product ID supplied from the ID generating block 133 to the optical disk 52 along with the encrypted content key supplied from the encryption block 134.

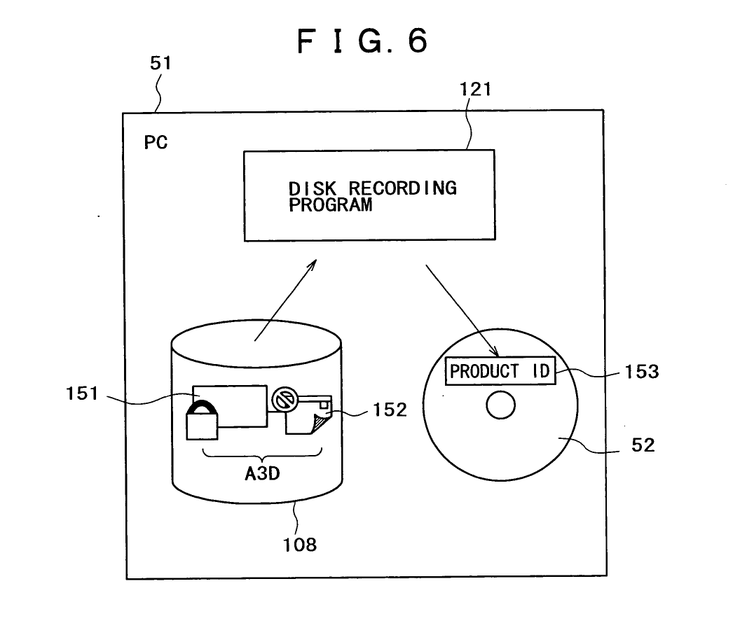

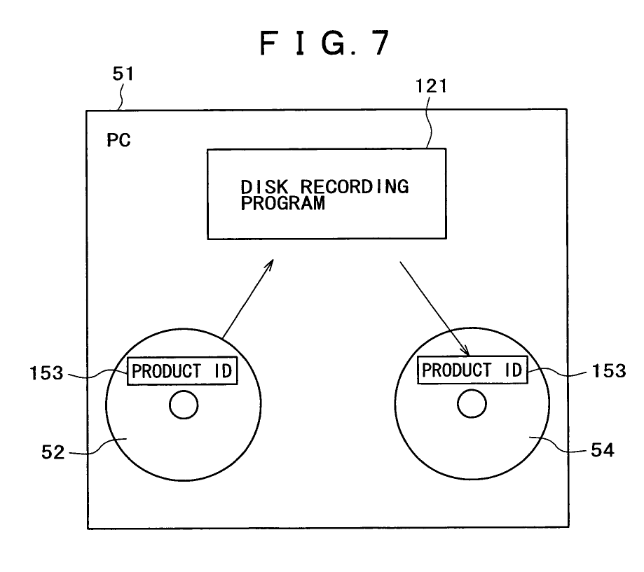

The following describes, in detail, operations of the PC 51 with reference to FIGS. 6 and 7. In this example, copyright-protected content 151 such as ripping and EMD and its license key 152 are obtained through the communication block 109 from a content distribution server, not shown, via a network, not shown. The copyright-protected content 151 is decrypted by the license key 152 and recorded to the storage block 108 as a plaintext content A3D. The optical disk 52 is loaded on the drive 110.

When the disk recording program 121 which has been read from any of the recording media, the magnetic disk 111 through the semiconductor memory 114, into the storage block 108 and loaded from it into the RAM 103 is executed by the CPU 101, the disk recording control block 131 shown in FIG. 5 executes the recording to the optical disk 52 shown in FIG. 6 or a backup operation from the optical disk 52 to the copy disk 54 shown in FIG. 7 under the user instruction entered through the input block 106.

First, an operation of recording the copyright-protected content from the storage block 108 which is the primary recording medium to the optical disk 52 which is the secondary recording medium will be described with reference to FIG. 6.

In the example shown in FIG. 6, when the recording of content A3D to the optical disk 52 is instructed by the user through the input block 106, the disk recording control block 131 controls the encryption block 134 encrypts content A3D stored in the storage block 108 by content key Kc. The encryption block 134 supplies encrypted content E(Kc, A3D) to the drive 110 via the bus 132. It should be noted that E(Kc, A3D) is indicative of the data obtained by encrypting A3D by Kc. Next, the disk recording control block 131 controls the encryption block 134 to encrypt content key Kc which has encrypted the content, by encryption key Kroot which is common to the reproducing apparatus 53. Then, the encryption block 134 supplies encrypted content key E(Kroot, Kc) to the drive 110 via the bus 132.

Also, the disk recording control block 131 controls the ID generating block 133 to generate a product ID 153 for identification of the PC 51, the disk recording program 121, and the recording environment (attribute) of the PC 51 at the time of recording the attribute of content A3D to be recorded. The ID generating block 133 supplies the generated product ID 153 to the drive 110 via the bus 132.

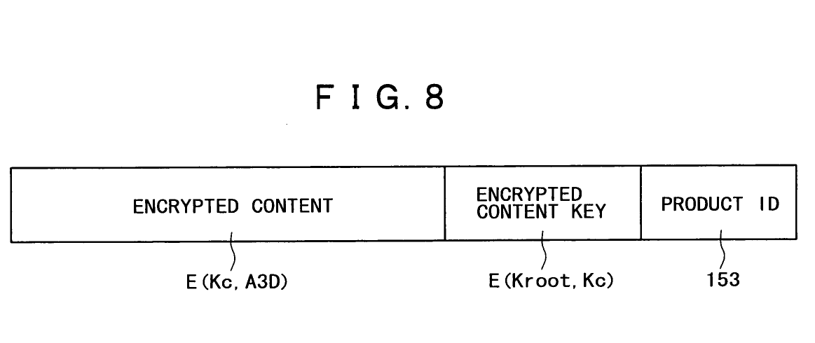

As shown in FIG. 8, the disk recording control block 131 controls the drive 110 to record encrypted content E(Kc, A3D) supplied from the encryption block 134 to the optical disk 52 and then the product ID 153 supplied from the ID generating block 133 to the optical disk 52 along with encrypted content key E(Kroot, Kc) supplied from the encryption block 134.

Referring to FIG. 8, there is shown a data structure of the data to be recorded to the optical disk 52. As shown in FIG. 8, the data to be recorded to the optical disk 52 are configured by encrypted content E(Kc, A3D), encrypted content key E(Kroot, Kc), and product ID 153 in this order.

The following describes an operation of recording (or copying) copyright-protected content from the optical disk 52 which is the primary recording medium to the copy disk 54 which is the secondary recording medium, with reference to FIG. 7 In the example shown in FIG. 7, when a backup operation for saving data from the optical disk 52 to the copy disk 54 is specified by the user through the input block 106, the disk recording control block 131 controls the drive 110 to store all data (encrypted content E(Kc, A3D), encrypted content key E(Kroot, Kc), and product ID 153)) recorded to the optical disk 52 into the ROM 102.

When the copy disk 54 is loaded on the drive 110, the disk recording control block 131 controls the drive 110 to record all data (encrypted content E(Kc, A3D), encrypted content key E(Kroot, Kc), and product ID 153)) from the ROM 102 to copy disk 54.

As described above, all data recorded to the optical disk 52 are copied onto the copy disk 54. Therefore, the copy disk 54 has the same product ID 153 of the PC 51 as that of the optical disk 52.

Referring to FIG. 9, there is shown an exemplary configuration of the reproducing apparatus 53. In the example shown in FIG. 9, a microcomputer 201 controls the reproducing apparatus 53 which is connected via a bus 202. The bus 202 is connected to a read block 203, a memory 204, and a decryption-block 205.

The read block 203 reads the product ID 153 (of the PC 51) from the loaded optical disk 52 and supplies the product ID 153 to the microcomputer 201 via the bus 202. The read block 203 also reads encrypted content key E(Kroot, Kc) or encrypted content E(Kc, A3D) from the optical disk 52 and supplies this key or content to the microcomputer 201 via the bus 202.

The memory 204 is constituted by a flash memory for example and has the product ID management table 211 for the management of each product ID first read by the drive 110 as an initialization product ID at a particular address. Once registered with this table, each initialization product ID can be neither deleted nor rewritten.

Receiving the product ID 153 of the optical disk 52 from the read block 203, the microcomputer 201 determines whether another product ID has been registered with the product ID management table 211 in the memory 204 as an initialization product ID. If initialization product ID is found not registered with the product ID management table 211, then the microcomputer 201 registers the product ID 153 of the optical disk 52 with the product ID management table 211 as an initialization product ID. Namely, the product ID 153 of the PC 51 is registered as an initialization product ID. The microcomputer 201 also stores encrypted content key E(Kroot, Kc) or encrypted content E(Kc, A3D) supplied from the read block 203 into an input register 212 of the decryption block 205.

The decryption block 205 has the input register 212. The decryption block 205 holds, in a particular area in the input register 212, encryption key Kroot common to the PC 51 which is obtained by encrypting encrypted content key E(Kroot, Kc). This encryption key Kroot was registered in the reproducing apparatus 53 at the shipment and the like in advance. Therefore, the decryption block 205 decrypts encrypted content key E(Kroot, Kc) stored in the input register 212 by use of encryption key Kroot in accordance with computation D(Kroot, E(Kroot, Kc)). It should be noted that D(Kroot, E(Kroot, Kc)) is indicative of the data obtained by decrypting E(Kroot, Kc) by Kroot.

In addition, by use of decrypted content key Kc, the decryption block 205 decrypts encrypted content E(Kc, A3D) held in the input register 212 in accordance with computation D(Kc, E(Kc, A3D)) and outputs decrypted content A3D to a D/A (digital/Analog) converter 206.

The D/A converter 206 converts content A3D supplied from the decryption block 205 from digital to analog and outputs the converted content to an output block 207 which is a speaker for example. Thus, the copyright-protected content (encrypted content E(Kc, A3D)) recorded to the optical disk 52 is reproduced.

On the other hand, if an initialization product ID is found already registered with the product ID management table 211, then the microcomputer 201 determines whether there is a match between the initialization product ID already registered with the product ID management table 211 and the product ID 153 of the optical disk 52. If a match is found, the microcomputer 201 controls other components of the reproducing apparatus 53 to reproduce the copyright-protected content recorded to the optical disk 52 as described above.

If a mismatch is found between the above-mentioned product IDs, the microcomputer 201 controls the other components of the reproducing apparatus 53 to restrict or disable the reproducing of the copyright-protected content of the optical disk 52. Namely, because the reproducing apparatus 53 has already been initialized by the product ID of another PC, the reproducing of the optical disk 52 having the product ID 153 of the PC 51 is restricted or disabled in the reproducing apparatus 53.

As described above, the reproducing of each optical disk having a product ID other than the initialization product ID is restricted in the reproducing apparatus 53. Therefore, this novel configuration can suppress the unlimited spreading of the right of reproducing for disk-copyable recording media (or optical disks).

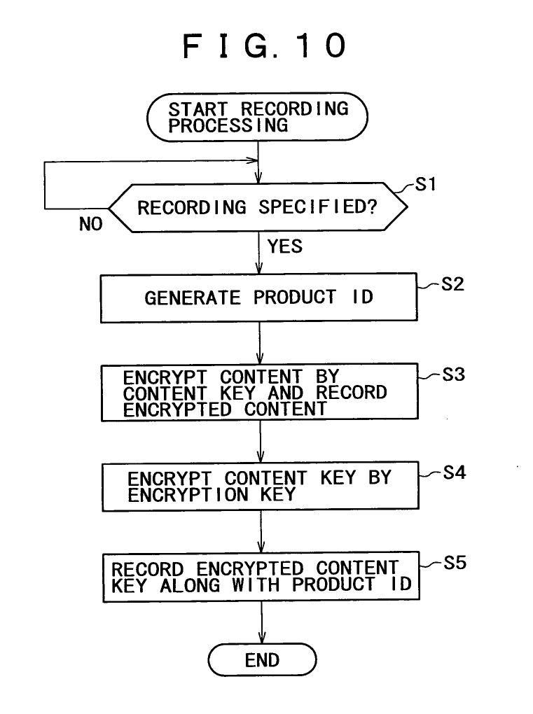

The following describes content recording processing for recording data to the optical disk 52 of the PC 51 with reference to the flowchart shown in FIG. 10. The CPU 101 executes the disk recording program 121 which has been read from any of the recording media, the magnetic disk 111 through the semiconductor memory 114, into the storage block 108 and loaded from it into the RAM 103.

In this case, the copyright-protected content 151 such as ripping or EMD and the license key 152 are obtained by the communication block 109 from a content distribution server, not shown, via a network, not shown. Then, the copyright-protected content 151 is decrypted by the license key 152 and stored in the storage block 108 as plaintext content A3D. It is assumed here that the optical disk 52 is loaded on the drive 110.

In step S1, the disk recording control block 131 is in a wait state until the recording of content to the optical disk 52 is instructed through the input block 106 from the user. When the instruction for recording content A3D is given by the user through the input block 106, the disk recording control block 131 goes to step S2 to control the ID generating block 133 to have it generate the product ID 153 for the identification of the PC 51, the disk recording program 121, and the recording environment (or attribute) of the PC 51 at the time of recording the attribute for example of the content to be recorded. The ID generating block 133 supplies the generated product ID 153 to the drive 110 via the bus 132 and goes to step S3.

In step S3, the disk recording control block 131 controls the encryption block 134 to encrypt content A3D stored in the storage block 108 by use of content key Kc. The encryption block 134 supplies content E (Kc, A3D) encrypted by content key Kc to the drive 110 via the bus 132. The drive 110 records received encrypted content E(Kc, A3D) to the optical disk 52 and goes to step S4.

In step S4, the disk recording control block 131 controls the encryption block 134 to encrypt, by use of encryption key Kroot common to the reproducing apparatus 53, content key Kc by which the content has been encrypted. Then, the encryption block 134 supplies encrypted content key E(Kroot, Kc) to the drive 110 via the bus 132 and goes to step S5.

In step S5, the disk recording control block 131 controls the drive 110 to record the product ID 153 supplied from the ID generating block 133 to the optical disk 52 along with encrypted content key E(Kroot, Kc) from the encryption block 134 after encrypted content E(Kc, A3D) recorded in step S3.

As described above, the product ID 153 for the identification of the PC 51, the disk recording program 121, and the recording environment (or attribute) of the PC 51 at the time of recording the attribute of the content to be recorded is recorded to the optical disk 52 along with the encrypted content.

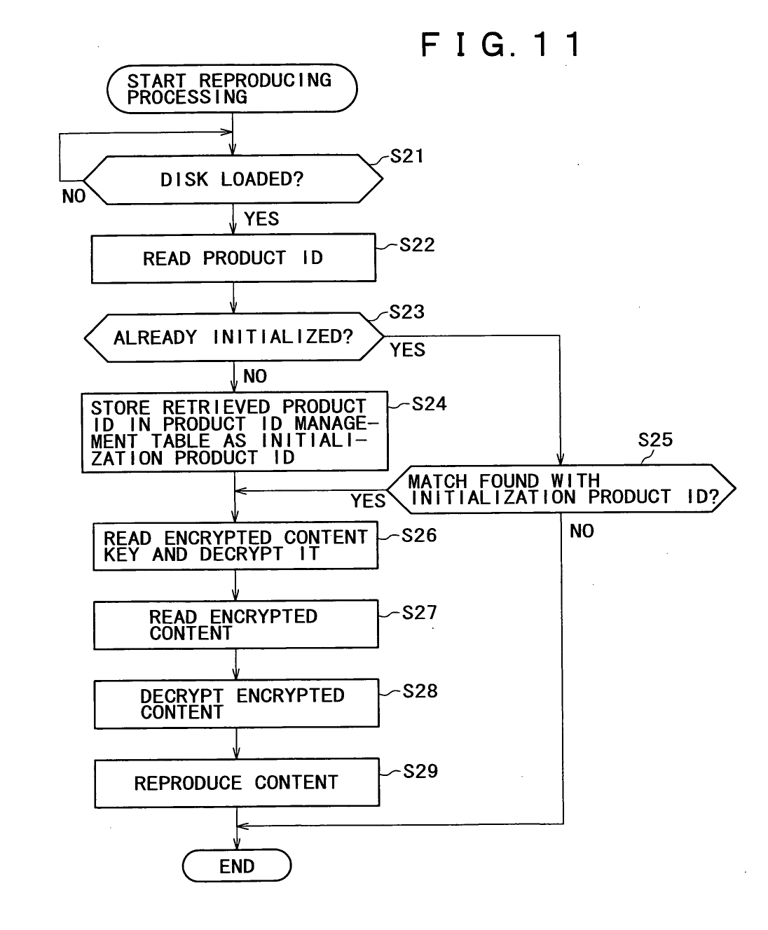

The following describes the processing of reproducing an optical disk loaded on the reproducing apparatus 53 with reference to the flowchart shown in FIG. 11.

In step S21, the read block 203 is in a wait state until the optical disk 52 is loaded. When the optical disk 52 is loaded, the read block 203 goes to step S22. In step 822, the read block 203 reads the product ID 153 of the PC 51 from the optical disk 52. Then, the read block 203 supplies this product ID 153 to the microcomputer 201 via the bus 202 and goes to step S23.

In step S23, the microcomputer 201 determines whether another product ID has been registered with the product ID management table 211 in the memory 204 as an initialization product ID. Namely, the microcomputer 201 determines whether the product ID management table 211 of the reproducing apparatus 53 has already been initialized. If initialization product ID is found not registered with the product ID management table 211 in step S23, then the microcomputer 201 goes to step S24 to register the product ID 153 of the optical disk 52 supplied from the read block 203 in step S22 with the product ID management table 211 as an initialization product ID and goes to step S26. Namely, the product ID management table 211 of the reproducing apparatus 53 is initialized by the product ID 153 of the optical disk 52.

On the other hand, if another initialization product ID is found registered with the product ID management table 211 in step S23, then the microcomputer 201 goes to step S25 to see if there is a match between the initialization product ID registered with the product ID management table 211 in the memory 204 and the product ID 153 of the optical disk 52 supplied from the read block 203 in step S22.

If there is a mismatch between the initialization product ID registered with the product ID management table 211 and the product ID 153 of the optical disk 52 in S25, then it indicates that the reproducing apparatus 53 has already been initialized by the product ID of another PC, so that the microcomputer 201 executes control of disabling the reproducing of the optical disk 52 and ends the optical disk reproducing processing of the reproducing apparatus 53 by skipping steps S26 through S29. It should be noted that, in this case, the microcomputer 201 executes control of disabling the reproducing of the optical disk 52 having the product ID 153 of the PC 51; alternatively, the microcomputer 201 may execute control of restricting the reproducing of the optical disk 52 such as reproducing only a particular band of the optical disk 52 or only a particular period of time.

If there is a match between the initialization product ID registered with the product ID management table 211 and the product ID 153 of the optical disk 52 in step S25, then the procedure goes to step S26.

In step S26, the microcomputer 201 controls the read block 203 to read encrypted content key E(Kroot, Kc) from the optical disk 52. Then, the read block 203 supplies this encrypted content key to the microcomputer 201 via the bus 202. The microcomputer 201 stores received encrypted content key E(Kroot, Kc) into the input register 212 of the decryption block 205 and controls the decryption block 205 to decrypt encrypted content key E(Kroot, Kc) in the input register 212 by use of encryption key Kroot in accordance with computation D(Kroot, E(Kroot, Kc)), going to step S27.

In step S27, the microcomputer 201 controls the read block 203 to read encrypted content (Kc, A3D) from the optical disk 52. The read block 203 supplies this encrypted content (Kc, A3D) to the microcomputer 201 via the bus 202. The microcomputer 201 stores the received encrypted content (Kc, A3D) into the input register 212 of the decryption block 205 and goes to step S28. In step S28, the decryption block 205 decrypts encrypted content E(Kc, A3D) stored in the input register 212 from the microcomputer 201 by use of content key Kc decrypted in step S26 in accordance with computation D(Kc, E(Kc, A3D)) and outputs decrypted content A3D to the D/A converter 206, going to step S29.

In step S29, the D/A converter 206 converts content A3D supplied from the decryption block 205 from digital to analog and reproduces the content through the output block 207 such as speaker for example.

As described above, an optical disk having a product ID which matches the initialization product ID is reproduced and the reproducing of any optical disks having a product ID other than the initialization product ID is restricted in the reproducing apparatus 53. Therefore, this novel configuration may restrict the spreading of the right of reproducing for disk-copyable recording media (optical disks).

It should be noted that, in the above description, the optical disk 52 is used for example and the product ID of the optical disk 52 is registered as an initialization product ID; the same processing is executed if the copy disk 54 is loaded before the original optical disk 52 when the initialization product ID has not yet been registered with the product ID management table. Namely, the product ID management table of the reproducing apparatus 53 is initialized by the ID of the optical disk which is first loaded and the product ID thereof is read (namely, the product ID of the PC which has recorded content to an optical disk).

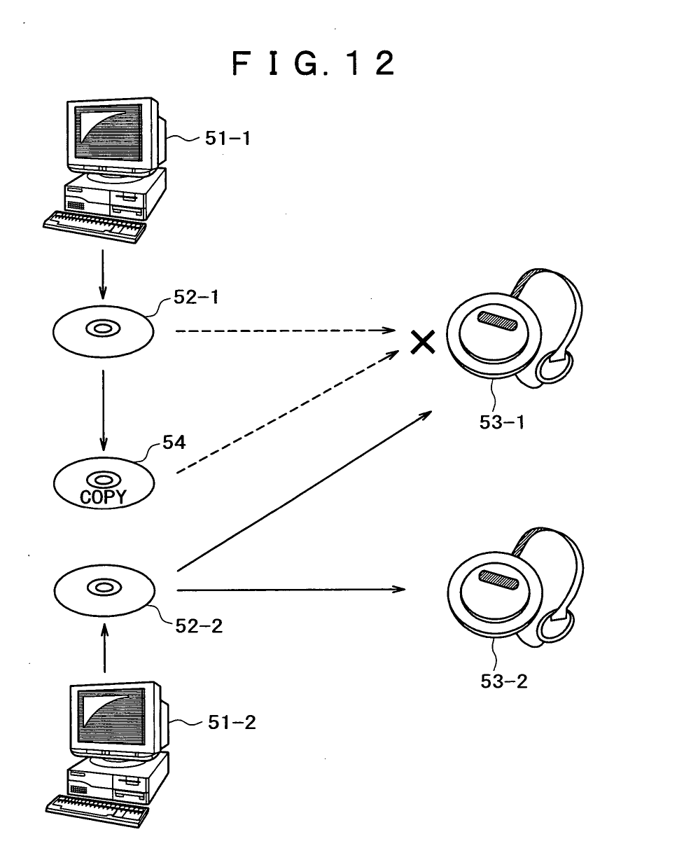

Referring to FIG. 12, there is shown another exemplary configuration of the recording/reproducing system. It should be noted that, with reference to FIG. 12, similar components described previously with reference to FIG. 3 are denoted by the same reference numerals and their description will be skipped for the brevity of description.

In the example shown in FIG. 12, user A loads, on a reproducing apparatus 53-1, an optical disk 52-2 having the product ID of a PC 51-2 owned by user B before an optical disk 52-1 having the product ID of a PC 51-1 of user A, by way of example. Consequently, the product ID of the PC 51-2 of user B is registered with a product ID management table 211 of the reproducing apparatus 53-1 of user A as an initialization product ID. Once initialized by the product ID of the PC 51-2, the reproducing apparatus 53-1 of user A can reproduce the optical disk 52-2 recorded by the PC 51-2 of user B, but cannot reproduce or can reproduce only in a restricted manner the optical disk 52-1 recorded by the PC 51-1 and a copy disk 54 generated by the PC 51-1 because of the difference between the initialization product IDs.

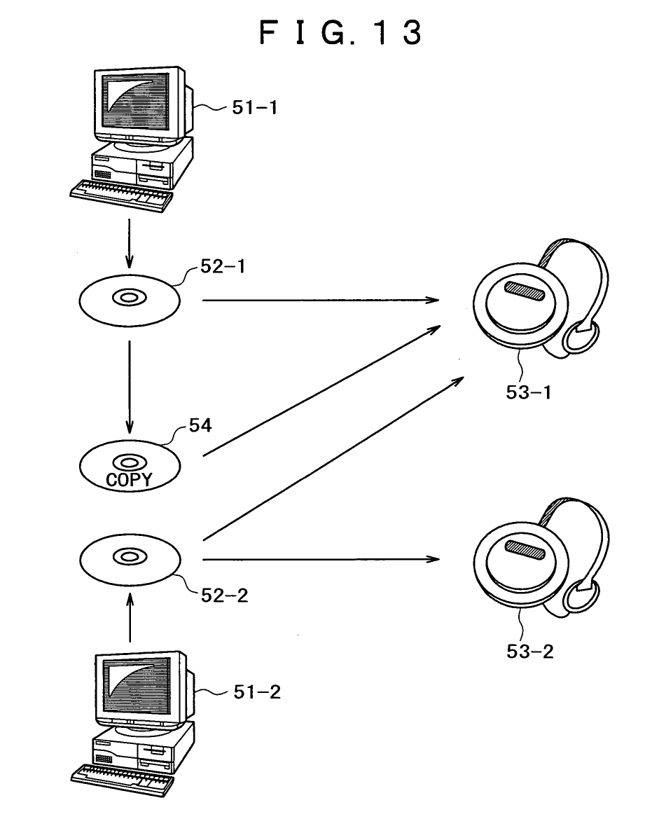

As described above, although it is his own reproducing apparatus, user A cannot reproduce the optical disk 52-1 and the copy disk 54 which are recorded by his own PC 51-1. The following describes a measure for solving this problem with reference to FIG. 13.

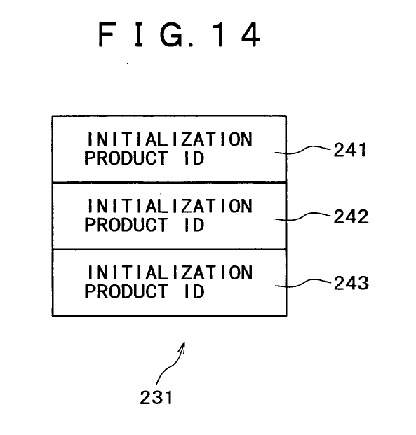

FIG. 13 shows still another exemplary configuration of the recording/reproducing system. It should be noted that, with reference to FIG. 13, similar components described previous with reference to FIG. 3 are denoted by the same reference numerals and their description will be skipped for the brevity of description. In FIG. 13, on the basis of the agreement by the copyright holders, a reproducing apparatus 53-1 gets a license having a plurality of initialization product IDs and stores a product ID management table 231 as shown in FIG. 14 in a memory 204.

FIG. 14 shows an exemplary configuration of the product ID management table 231 stored in the memory 204. In the example shown in FIG. 14, the product ID management table 231 can store three initialization product IDs, ID 241 through ID 243. Consequently, three product IDs can be registered as initialization product IDs in the reproducing apparatus 53-1, so that optical disks 52 recorded by three PCs having different product IDs can be reproduced.

Consequently, in the example shown in FIG. 13, if user A loads an optical disk 52-2 recorded with the product ID of a PC 51-2 of user B before an optical disk 52-1 recorded with the product ID of his own PC 51-1 and therefore the product ID of the PC 51-2 is registered with the product ID management table 231 of the reproducing apparatus 53-1 as the initialization product ID 241 as with the example shown in FIG. 12, the product ID management table 231 can still store two other product IDs as the initialization product IDs 242 and 243.

Namely, if the product ID management table 231 of the reproducing apparatus 53-1 of user A has been initialized by the product ID of the PC 51-2 of user B, loading the optical disk 52-1 recorded by the PC 51-1 of user A or the copy disk 54 generated by the PC 51-1 of user A onto the reproducing apparatus 53-1 of user A registers the product ID of the PC 51-1 with the product ID management table 231 as the initialization product ID 242. Therefore, in the reproducing apparatus 53-1 of user A, the optical disk 52-1 and the copy disk 54 recorded by the PC 51-1 of user A and the optical disk 52-2 recorded by the PC 51-2 of user B can be reproduced without restriction.

As described above, the ease of use by the user can be enhanced by obtaining the license for increasing the number of initialization product IDs to be registered as with the product ID management table 231 when optical disks recorded by user's friends are reproduced or when one user has a plurality of PCs and the like.

In the above-mentioned examples, audio data are used for the content to be recorded on optical disks. It will be apparent not only that video data may be used for the content to be recorded, but also that software may be recorded on optical disks instead of content. Although the optical disks are recorded by PCs, it will be apparent that recording apparatuses or recording/reproducing apparatuses may record the optical disks.

In the above-mentioned examples more, it will be apparent that the recording media are not only optical disks but also Memory Cards (trademark) of other than the recording media may be used.

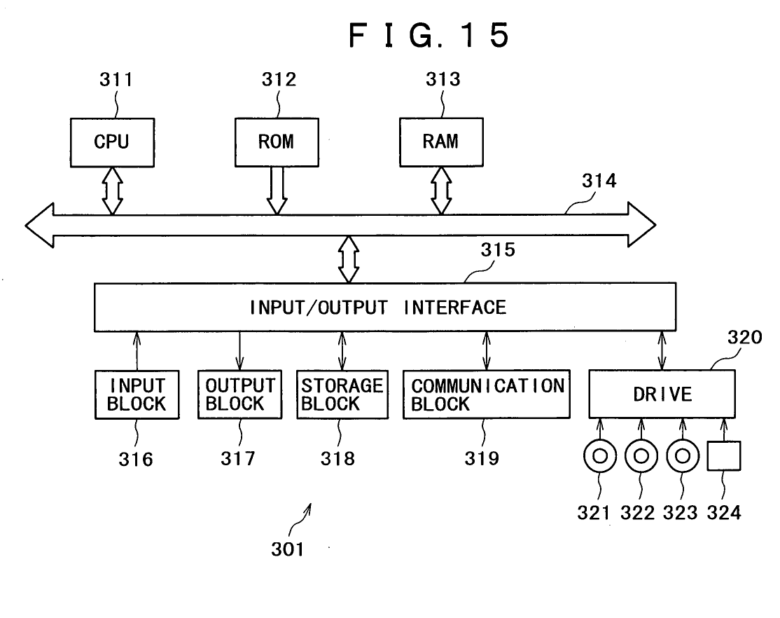

The above-mentioned sequence of processing operations may be executed by hardware or software. In this case, the reproducing apparatus 53 shown in FIG. 9 is configured by a reproducing apparatus 301 such as shown in FIG. 15.

Referring to FIG. 15, a CPU (Central Processing Unit) 311 executes a variety of processing operations as instructed by programs stored in a ROM (Read Only Memory) 312 or loaded from a storage block 318 into a RAM (Random Access Memory) 313. The RAM 313 properly stores necessary data and the like for the CPU 311 to execute a variety of processing operations.

The CPU 311, the ROM 312, and the RAM 313 are interconnected via a bus 314. The bus 314 is also connected to an input/output interface 315.

The input/output interface 315 is connected to an input block 316 constituted by a keyboard and mouse and the like, an output block 317 constituted by a display device constituted by a CRT (Cathode Ray Tube) or an LCD (Liquid Crystal Display) or a speaker, a storage unit 318, and a communication block 319 constituted by a modem or terminal adaptor. The communication block 319 executes communication processing via a network, not shown.

The input/output interface 315 is also connected to a drive 320 as required, on which a magnetic disk 321, an optical disk 322, a magneto-optical disk 323, or a semiconductor memory 324 are properly loaded. Then, computer programs read from any of these recording media being installed in the storage block 318 as required.

When the above-mentioned sequence of processing operations is executed by software, the programs constituting the software are installed in a computer which is built in dedicated hardware equipment or installed, from a network or recording media, into a general-purpose personal computer for example in which various programs may be installed for the execution of various functions.

As shown in FIGS. 4 and 15, these recording media are constituted by not only a package media made up of the magnetic disk 111 or 321 (including flexible disks), the optical disk 112 or 322 (including CD-ROM (Compact Disk Read Only Memory) and DVD (Digital Versatile Disk)), the magneto-optical disk 113 or 323 (including MD (Mini Disk) (trademark)), or the semiconductor memory 114 or 324 which is distributed separately from the apparatus itself, but also the ROM 102 or 312 or the storage unit 108 or 318 which stores programs and is provided to users as incorporated in the apparatus itself.

It should be noted herein that the steps for describing each program recorded in recording media include not only the processing operations which are sequentially executed in a time-series manner but also the processing operations which are executed concurrently or discretely.

The term “system” as used herein denotes an apparatus in its entirely which is constituted by a plurality of component units.

As described and according to the invention, the reproducing of disk-copyable recording media can be restricted.

While the preferred embodiments of the present invention have been described using specific terms, such description is for illustrative purposes only, and it is to be understood that changes and variations may be made without departing from the spirit or scope of the following claims.

What is claimed is:

1. A reproducing method for reproducing information recorded to a recording medium, comprising the steps of:
obtaining, from said recording medium, a recording ID for identifying a recording environment in which said information was recorded to said recording medium;
determining as a first determination step whether said recording ID has already been registered as an initialization recording ID;
registering said recording ID obtained in the obtaining step as said initialization recording ID if said initialization recording ID is found not yet registered in said first determination step;
determining, as a second determination step, whether or not said recording ID obtained in said obtaining step matches said initialization recording ID if said initialization recording ID is found already registered in said first determination step; and
executing control of disabling or restricting the reproducing of said information recorded on said recording medium if said recording ID is found mismatching said initialization recording ID in said second determination step.

2. The reproducing method according to claim 1, wherein said recording ID is an ID for identifying a recording apparatus which recorded said information to said recording medium.

3. The reproducing method according to claim 1, wherein said initialization recording ID, once registered, cannot be deleted and rewritten.

4. The reproducing method according to claim 1, further comprising the steps of:
reading an encryption key by which said information was encrypted from said recording medium if said recording ID is found matching with said initialization recording ID in said second determination step; and
decrypting said information recorded to said recording medium by use of said encryption key read in the reading step;
wherein the reproducing control step also executes control of reproducing said information decrypted in the decryption step.

5. A reproducing apparatus for reproducing information recorded to a recording medium, comprising:
obtaining means for obtaining, from said recording medium, a recording ID for identifying a recording environment in which said information was recorded to said recording medium;
first determining means for determining whether or not said recording ID has already been registered as an initialization recording ID;
registering means for registering said recording ID obtained by said obtaining means as said initialization recording ID if said initialization recording ID is found not yet registered in said first determination step;
second determining means for determining whether said recording ID obtained by said obtaining means matches said initialization recording ID if said initialization recording ID is found already registered by said first determining means; and
reproducing control means for executing control of disabling or restricting the reproducing of said information recorded on said recording medium if said recording ID is found mismatching said initialization recording ID by said second determining means.

6. A program recording medium for recording a computer-readable program having a computer execute processing of reproducing information recorded to a recording medium, comprising:
obtaining, from said recording medium, a recording ID for identifying a recording environment in which said information was recorded to said recording medium;
determining as a first determination step whether or not said recording ID has already been registered as an initialization recording ID;
registering said recording ID obtained in the obtaining step as said initialization recording ID if said initialization recording ID is found not yet registered in said first determination step;
determining, as second determination step, whether or not said recording ID obtained in said obtaining step matches said initialization recording ID if said initialization recording ID is found already registered in said first determination step; and
executing control of disabling or restricting the reproducing of said information recorded on said recording medium if said recording ID is found mismatching said initialization recording ID in said second determination step.

7. A program for having a computer execute processing of reproducing information recorded to a recording medium, comprising the steps of:
obtaining, from said recording medium, a recording ID for identifying a recording environment in which said information was recorded to said recording medium;
determining as a first determination step whether or not said recording ID has already been registered as an initialization recording ID;
registering said recording ID obtained in the obtaining step as said initialization recording ID if said initialization recording ID is found not yet registered in said first determination step;
determining, as second determination step whether or not said recording ID obtained in said obtaining step matches said initialization recording ID if said initialization recording ID is found already registered in said first determination step; and
executing control of disabling or restricting the reproducing of said information recorded on said recording medium if said recording ID is found mismatching said initialization recording ID in said second determination step.

8. A recording method for recording information to a recording medium, comprising the steps of:
generating a recording ID for identifying a recording environment in which said information is recorded to said recording medium;
encrypting said information by an encryption key; and
recording said information encrypted in the encryption step to said recording medium and recording said recording ID generated in the generating step along with said encryption key.

9. A recording apparatus for recording information to a recording medium, comprising:
generating means for generating a recording ID for identifying a recording environment in which said information is recorded to said recording medium;
encrypting means for encrypting said information by an encryption key; and
recording means for recording said information encrypted by said encrypting means to said recording medium and recording said recording ID generated by said generating means along with said encryption key.

10. A program recording medium for recording a computer-readable program having a computer execute processing of recording information to a recording medium, comprising:
generating a recording ID for identifying a recording environment in which said information is recorded to said recording medium;
encrypting said information by an encryption key; and
recording said information encrypted in the encryption step to said recording medium and recording said recording ID generated in the generating step along with said encryption key.

11. A program for having a computer execute processing of recording information to a recording medium, comprising the steps of:
generating a recording ID for identifying a recording environment in which said information is recorded to said recording medium;
encrypting said information by an encryption key; and
recording said information encrypted in the encryption step to said recording medium and recording said recording ID generated in the generating step along with said encryption key.

12. A recording medium for recording information which records said information and a recording ID for identifying a recording environment in which said information was recorded to said recording medium.
